(19) United States
(12) Patent Application Publication
(10) Pub. No.: US 2007/0130279 A1
(43) Pub. Date: Jun. 7, 2007

(54) GEO-FENCE LOCATION-SPECIFIC EQUIPMENT STATUS BASED TRIGGER DIRECTED CONTENT DELIVERY

(75) Inventor: Jeffery W. THACHER, Roswell, GA (US)

Correspondence Address: SMITH FROHWEIN TEMPEL GREENLEE BLAHA, LLC, Two Ravinia Drive, Suite 700, ATLANTA, GA, 30346, US

(73) Assignee: DISCRETE WIRELESS, Atlanta, GA (US)

(21) Appl. No.: 11/164,679

(22) Filed: Dec. 1, 2005

(51) Int. Cl. G06F 15/16

(52) U.S. Cl. 709/208

(57) ABSTRACT

A dispatcher free control system that combines location and tracking technology with wireless communication technology to enable deployed workers to be tracked and assisted while on the job. More particularly, mobile units are deployed with the work force. The mobile units include location tracking technology such as GPS, and wireless communication technology such as digital cellular. The mobile devices communicate via the wireless communication technology to a control system. The control system maintains a database of information about various jobs, work orders, status, or the like. In response to status based events, the mobile devices communication with the control system to obtain and update information regarding the work orders and status.

### CROSS-REFERENCE TO RELATED APPLICATIONS

The present invention is related to, and incorporates by reference, U.S. patent application entitled AUTO MAPPING THROUGH LOCATION BASED TRIGGERS, filed on the same day as the present application and having attorney docket number 04003.1030 and assigned Ser. No. 10/______.

### BACKGROUND OF THE INVENTION

This invention is related to the fields of geocentric location devices and systems, and distributed system communications and, more particularly to devices that include location determination capabilities and that operate as part of a deployed system that utilizes reporting of current positions of the equipment to determine particular actions to be performed.

Any person that has ever attempted to run a business involving the deployment of various workers or employees throughout a dispersed geographic region will have a keen understanding of the need to know where your forces are at any particular time, what they are presently doing, and what they have recently done. Such knowledge can be greatly beneficial in optimizing the efficiency of such businesses. This is true for a variety of companies, including companies such as taxi or limo services, courier services, maintenance and repair companies, delivery services, as well as a wide variety of other services.

A revolutionary technological event for such companies occurred with the advent of two-way radio technology. The introduction of this technology created the ability for dispatchers to contact individuals that were out in the field, obtain location information and provide additional instructions as well as modify their schedules. This technology also enables the deployed forces to periodically check in and update the dispatcher. This technique, although state of the art at its time, was quite cumbersome, not real-time, and was prone to operator error.

Another revolutionary technological advancement that has not yet been fully utilized and appreciated in the industry, is location identification and tracking technology. The most commonly known system that has reached wide-spread deployment is the Global Positioning System or GPS. GPS technology includes multiple geostationary satellite systems that provide location and timing signals to earth bound GPS receivers. Such technology can greatly improve the ability for companies to keep track of their assets or mobile forces.

In addition, prior to the advent of wireless communications, service companies that relied on the use of deployed work forces typically would distribute work orders at the beginning of a work day and then deploy their work forces. If information pertaining to entries in a particular person's work order changed, the company or dispatcher would not be able to alert the worker unless the worker called in during the day or, if the company was able to track the worker down by calling the various locations that the worker should be visiting in accordance with his or her work orders. With the widespread deployment of wireless communications including pagers, two-way radios and cellular technologies, the ability to keep track of and update the work orders for various workers was greatly enhanced.

However, what is needed in the art is a system that takes advantage of the technology developments in location identification technology and wireless communications to help improve the efficiency of a deployed work force oriented business. In addition, what is needed in the art is a system to identify the location of a company's deployed assets and provide the deployed asset with work order information relevant to a job tied to the identified location and/or particular equipment at that location. What is also needed in the art is an automated dispatcher capability that can track deployed forces, automatically adjust work orders to more efficiently service customers, and collect and provide current status and information for various projects in a real-time manner.

### BRIEF SUMMARY OF THE INVENTION

The present invention addresses the above-identified needs in the art, as well as other needs in the art through providing a system that includes a plurality of mobile units that communicate with a centralized control system. The mobile units include technology that enables the mobile devices to identify their physical location at any particular time, and wireless communication technology to enable constant communication with the control system to deliver the location information, as well as measurement/status information, and then receive directed content based on the provided measurement/status information and location information. In operation, mobile devices are deployed along with the work forces for a particular company. The mobile devices can be used in a variety of manners to solve needs for a variety of companies but, in general, operate by generating triggers that are based on location events or other events, transmitting notification of these events to the control system, the control system then responding by analyzing the trigger notification and performing various tasks based on the triggering event.

In various embodiments, the triggering events can include location based triggers and operation based triggers. Location based triggers that occur based on the physical location of the mobile device. The operation based triggers can occur when the mobile device or equipment associated with the mobile device performs various functions or meet particular criteria. For instance, if an expected threshold value is exceeded when a particular measurement is taken, this could result in a trigger that invokes the control system to down load instructional information regarding the measurement, expected values, accepted values and maintenance steps that need to be performed. Similarly, simply taking the measurement may result in a trigger. For instance, the measurement may be immediately uploaded to the control system, analyzed and then appropriate actions taken such as instructing the field technician to conduct various adjustments or part replacements. Another example would be using a scanning device to read a bar code or other form of serial number. Once a bar code or serial number is read, it is provided to the control system and then pertinent information related to the equipment associated with that barcode or serial number can be accessed. Yet another example would include a worker entering a call detail record where certain defined details or language request more information or provides measurements or both, and then transmitting the call detail record control system which responds with the additional information.

Advantageously, the present invention combines the benefits realized in location based technology and wireless communications to provide a more efficiently run business. Mission critical information can be provided to the deployed work force in real-time and updated information can be incorporated into the system in real-time. Information can be provided to the deployed workforce as they need it—for instance through location based triggers—and as such, can be guaranteed to be fresh and updated information. In addition, this can be accomplished without any intervention from a human dispatcher, thereby eliminating any detriments or limitations associated with the “human” factor.

### BRIEF DESCRIPTION OF THE SEVERAL VIEWS OF THE DRAWING

FIG. 1 is a diagram illustrating a conceptual environment suitable for an embodiment of the present invention.

FIG. 2 is a system diagram of the various components and devices of an exemplary system that could be utilized to implement embodiments of the present invention.

FIG. 3 is a block diagram of an exemplary mobile device suitable for embodiments of the present invention.

FIG. 4 is a flow diagram illustrating the steps involved in various embodiments of the present invention.

### DETAILED DESCRIPTION OF THE INVENTION

The present invention is directed towards providing information to mobile participants and/or receiving information from the mobile participants based on the occurrence of one or more status events. As will be more fully described, the various aspects of the present invention can be utilized in a wide array of applications and industries. Utilizing an integration of location oriented technology, such as the Global Positioning System, and messaging technology, such as email, short messaging, wireless technology or the like, mobile participants are able to function in a more efficient, traceable and reliable manner.

More specifically, one aspect of the present invention operates to receive one or more location based triggers from a mobile participant, and then provides information to that mobile participant that can help, or is required, in the performance of certain tasks. Another aspect of the present invention is to receive feedback from the mobile participant regarding the status of the task, and tying such status to an overall information database that is related to the task and/or the geocentric information pertaining to the mobile participant. Advantageously, the present invention and the various aspects of the present invention enable companies to efficiently manage their mobile resources with location relevant and time-sensitive information. Now turning to the figures in which the various labels refer to like elements, various embodiments, aspects and functions of the present invention are presented.

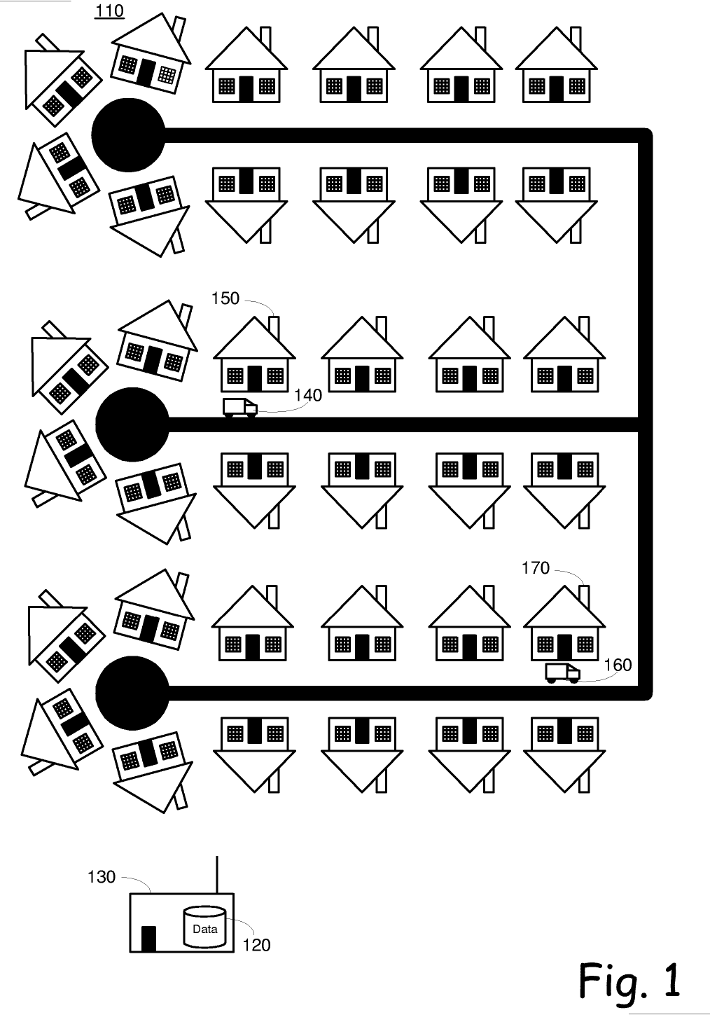

FIG. 1 is a diagram illustrating a conceptual environment suitable for an embodiment of the present invention. The conceptual environment is a typical suburban neighborhood development 110 and will be used to illustrate the location based and status based trigger with directed content delivery aspects of the present invention. Each housing unit in the neighborhood can be identified within a database system 120 as a particular project. The database system 120 is stored and operated within the dispatch can control system 130. For example, each housing unit in the neighborhood may include a collection of information stored within the database system 120 and indexed by the lot number, address, longitude/latitude location or some other identifying tag. The entries within the database system 120 can be any of a variety of information types but, for the example being provided, the database system 120 contains work orders, completed work order notes, and various status reports pertaining to the heating, ventilation and air-conditioning HVAC units for the housing unit. For example, for a first housing unit 150, an exemplary database entry could include the following information:

Project 150-021: Installed A/C unit Carrier Model No. 457.

Project 150-021: Measurements taken of the units airflow, temperature by the thermostat, measured temperature output and Freon pressure.

Project 150-437: Changed filters and cleaned intakes.

Project 150-438: Installed hyper-allergenic filtering system.

Project 150-439: Installation of humidifying unit.

Status 150-233: Freon pressure.

Report 150-211: For Project 150-439 reporting percentage of humidity injection.

Similarly, a second housing unit 170 may include a variety of entries in the database system 120.

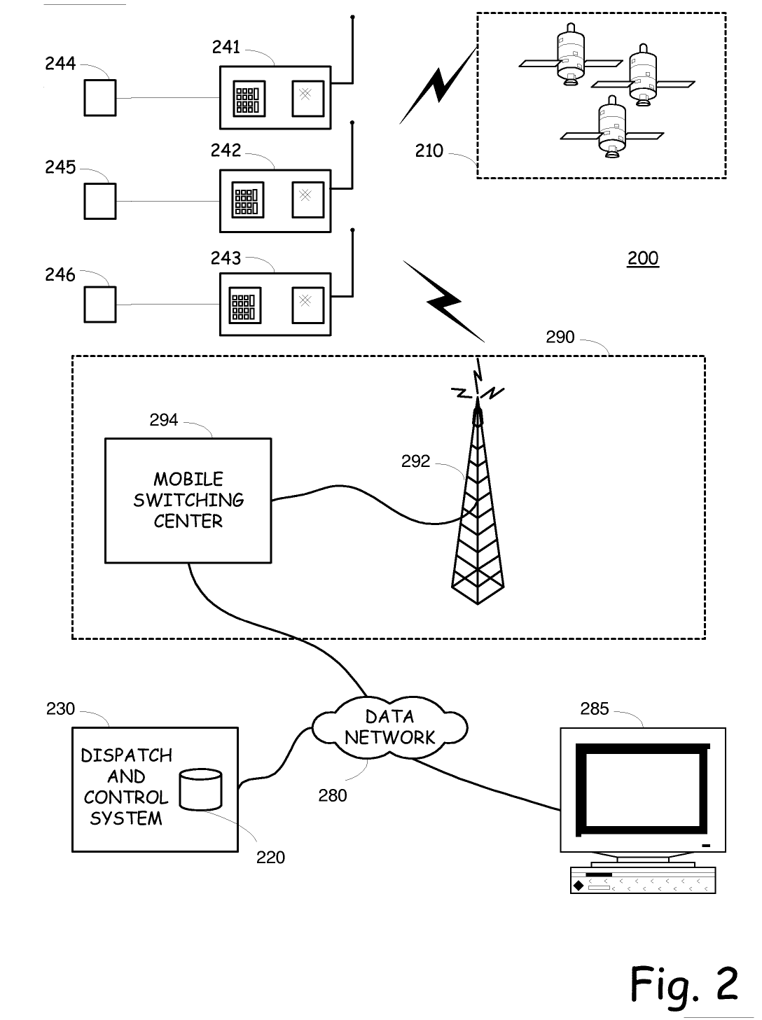

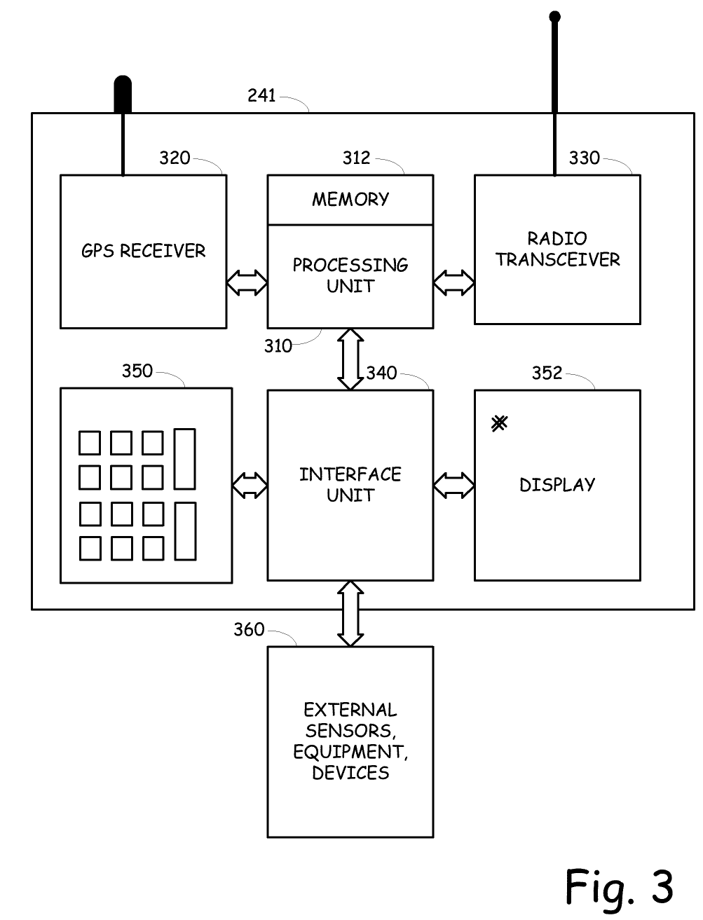

Suppose that an HVAC worker pulls up to the housing unit 150 in work truck 140. The work truck 140 is equipped with a Global Positioning System (GPS) receiver and a mobile communication device similar to the one described in conjunction with FIGS. 2 and 3 below. When the work truck 140 is in the vicinity of the housing unit 150, the GPS coordinates are transferred to the dispatch headquarters 130. In response to the reception of the GPS coordinates identifying the first housing unit 150, entries from the database system 120 can be retrieved and sent to the mobile communication device. In addition, the transmission of the GPS coordinates may also include an identification of the truck 140. In this example, the truck 140 is assigned or operated by a particular HVAC worker that installs humidifiers. Thus, the control system 130 could retrieve the Project 150-439 from the database system 120 and forward the project description, along with detailed instructions, current configuration settings, etc. to the mobile communication device associated with the truck 140.

It should be noted that such a system can actually provide automated dispatch services on a real-time basis. For instance, if truck 160 visiting housing unit 170 causes damage to the humidifying unit in the housing unit 170, in accordance with one embodiment of the present invention, the worker associated with truck 160 can provide a status based trigger to the control system 130 regarding the damage, followed up with additional details and pictures of the damage. When the HVAC humidifier worker associated with truck 140 reports back that the work order at housing unit 150 is completed, the control system 130 may notice that the truck 140 is in the vicinity of housing unit 170 and thus, may pull the notice regarding the humidifier damage to housing unit 170 out of the database and provide the same to work truck 140. Thus, the present invention operates as an automated, human free, dispatch system.

In addition, as the HVAC worker performs various tasks, such as taking measurements or the like through the use of measurement equipment communicatively coupled to a mobile device utilized by the HVAC work, these measurements are provided to the control system 130 and invoke the provision of additional information. Thus, as the truck 140 approaches the housing unit 150, the location of the truck 140 is provided to the control system 130 which then operates to at least point to data in the database 120 that is relevant to the housing unit 150. In addition, particular information may actually be pulled from the database and provided to the mobile device. In addition, as measurements are taken and provided to the control system, further information can be extracted from the database 120 or recorded into the database 120.

FIG. 2 is a system diagram of the various components and devices of an exemplary system that could be utilized to implement embodiments of the present invention. The system 200 includes various components that are communicatively coupled to each other using various communication techniques. A geostationary orbiting satellite positioning system 210 operates to provide signals to mobile devices 241, 242 and 243. These satellite signals can be used by the mobile devices to identify the location of the mobile devices. The operation of such a typical geostationary orbiting satellite positioning system is well known to those skilled in the art. The most common satellite system that operates to provide such information is GPS. The GPS is a constellation of 24 well-spaced satellites that orbit the Earth at 10,600 miles above sea level. The satellites are spaced at such intervals and altitude that for any given point on the Earth, at least four satellites will be communicatively seeable, or above the horizon. Each satellite in the GPS constellation includes a computer system, an atomic clock, and a transmitter. The satellites continuously transmit a data stream that identifies the current position of the satellite and the current time. Through the detection and decoding of these GPS signals, the mobile units are able to identify the longitudinal and latitudinal coordinates at which the mobile device is located. However, it should be appreciated that the present invention is not limited to operation with GPS and other location technologies can also be utilized. Thus, when the term GPS is used within the context of this description, it is synonymous with other compatible location determining technologies unless otherwise stated.

The mobile devices 241, 242 and 243 include an interface to external equipment that is used for obtaining measurements, making adjustments etc. This information is provided to the mobile devices 241, 242 and 243 over a wireless or tethered communication channel to equipment 244, 245 and 246. For example, the interface could be a WiFi connection, USB, Firewire, RS232 or any of a variety of other technologies.

The mobile devices 241, 242 and 243 are equipped not only to receive or determine location information and measurement/adjustment data, but also to transmit such information to a control system 230 through a communications medium. In the illustrated embodiment, the communications medium is a cellular telephone network utilizing technology such as GSM with GPRS, CDMA, TDMA, or other comparable technologies. This technology enables the communication of data between the mobile devices and the control system. The cellular based data transmissions from the mobile devices 241, 242 and 243 are received by the mobile system 290 at antenna 292 and are provided to the mobile switching center 294. The mobile switching center then provides the received data transmissions to the control system 230 through a data network 280.

The control system 230 is also functional to transmit data to the mobile devices 241, 242 and 243 through the data network 280 and the cellular system 290. The control system 230 includes a database system 220 that houses, among other things, data utilized for various embodiments of the present invention. Each of the mobile devices 241, 242 and 243 is shown as including a display and a key pad. Such elements can be included in various embodiments of the present invention in addressing various aspects and functions of the invention and allow a user of the mobile device to review information received from the GPS transmitters and the control system, and to enter additional information to be provided back to the control system 230. Although not illustrated, it should be appreciated that the mobile devices may also interface to other data devices such as scanners, digital cameras, audio devices, analog to digital converters, an automobile data bus, measurement equipment, digital clocks, or other various devices.

The control system 230 includes the database system 220. As described in conjunction with FIG. 1, the database system 220 can contain a variety of information depending on the various embodiments of the present invention. The database system 220 and the control system 230 may also be accessed via computer 285. Such a system allows the information in the database and information regarding the various mobile devices to be accessed from any computer system connected to the control system 230 through the data network 280.

FIG. 3 is a block diagram of an exemplary mobile device suitable for embodiments of the present invention. The mobile device 241 is an all-in-one self-contained box that includes various external connectors. Having all of the functional components within a single box allows for rapid and ease of installation. The mobile device is small and lightweight for easy transportation. The overall operation of the mobile device 241 is controlled by a processing unit 310 that includes memory element 312 for housing the software or firmware for defining the operation of the device, as well as temporary variables and status indicators. The mobile device 241 includes a GPS receiver 320 and a radio transceiver (transmitter and receiver) 330. Under control of the processing unit 310, the GPS receiver 320 can be enabled to detect signals from the GPS satellites and determine the location of the mobile device 241. The location information is then provided to the processing unit 310 for storage in memory 312 or for immediate transmission through radio transceiver 330. The processing unit 310 can interface to various input and/or output devices through an interface unit 340. For instance, the processor can receive key actuations from keypad 350 and display status or other information on display 352. The processing unit 310 can interface to external devices 360, measurement equipment, analog inputs, digital inputs or instrumentation through the interface unit 340 using a variety of wireless and wired technologies. For instance, a measurement device may provide an RF, digital or analog signal to the processing unit for storage, processing or otherwise acting upon.

The processing unit 310 may also receive information through the radio transceiver 330 such as status, data and operational commands. As an example, the mobile device 241 may receive a request from the control system 230 to provide the current location of the mobile device 241. In response to receiving the request through the radio transceiver 330, the processing unit enables the GPS receiver 320 to decode the current location. This information is then transmitted to the control system 230. Similarly, the processing unit 310 may periodically request the GPS receiver 320 to measure the current location of the mobile device 241. When the mobile device 241 enters into a particular area, this status information may be automatically transmitted by the processing unit 310 through the radio transceiver 320. Thus, depending on the various configurations, the location of the mobile device 241 can be continuously monitored, or it can simply report as it moves between or near areas of interest.

As has been described, the general scope of the present invention is the interaction of a control system with various mobile devices operating within a system. One aspect of the present invention is the various mechanisms or triggers that invoke such interaction. In general, there are two types of systems or methods for devices to talk to each other. These general methods include: (a) polling or (b) interrupt driven. In a polled environment, a master or controller periodically or a’ periodically communicates with another device, such as a slave device, to ensure the device is still active, to determine if the device needs any input or actions to be taken, or simply to provide information to or extract information from the device. In an interrupt driven system, devices autonomously communicate back to a master or central system either based on a schedule or the occurrence of an event. There are advantages and disadvantages to both techniques and the bottom-line deciding factor typically turns on the particular application or usage. In the present invention, a central system, the control system, is contacted by multiple mobile devices in an autonomous manner—interrupt driven. However, it should be understood that embodiments of the invention may also utilize polled communication initiated by the control system.

In the present invention, the interrupts, or more aptly termed, triggers, that are associated with this aspect of the present invention and invoke communication from the various mobile devices fall into two categories: (a) triggers initiated by the mobile device receiving GPS or location information and (b) triggers initiated by operation of the mobile device or a peripheral to the mobile device or operator initiated triggers.

Mobile Device Initiated Triggers

The mobile device initiated triggers, although predominately based on GPS information, can be generated from a variety of circumstances. For instance, each time the mobile unit 241 is moved (which can be detected through the GPS receiver 320), the mobile device 241 may trigger an alert to the control system 230. In another embodiment, the control system 230 may load location parameters into the mobile device 241 through a radio transmission to the radio transceiver 330. These parameters can define alert zones. If the mobile device 241 enters into or approaches one of the alert zones (or exits an alert zone) the mobile device 241 can transmit a message to the control system 230. This aspect of the present invention can be used to notify the control system 230 as to the current location of the mobile device 241, the transportation routes of the mobile device 241 and when the mobile device 241 is in an area that requires attention.

For instance, in the example provided with reference to FIG. 1, when the first truck 140 housing a mobile device 241 arrives in front of housing unit 150, the mobile device 241 can notify the dispatch and control center 230. In response to this notification, the dispatch and control center 230 may transmit a work order to the mobile device including instructions, pictures, and other attachments to help facilitate completion of the job. In another embodiment, each time the mobile device is stationary for more than 3 minutes, a trigger message could be transmitted to the control system 230. Thus, it will be appreciated that any of a variety of conditions could be applied based on the location or movement of the mobile device. In general, this aspect of the present invention operates to notify the control system 230 regarding location or movement information of the mobile device 241 and then, depending on the embodiment, the control system 230 can take the necessary actions.

Operator Initiated Triggers

The operator initiated triggers are based on actions taken by an operator of the mobile device 241 or a peripheral element to the mobile device, as well as non-location oriented triggers that may be generated by the mobile device autonomously to the operator. In addition, non-operator based events may also be used to initiate these triggers, such as measurements or the detection of certain conditions. Those skilled in the art will appreciate that many such triggering events could be implemented and a few examples are provided as non-limiting examples.

One of the operator initiated triggers occurs when a field technician using the mobile device 241 and a measuring device coupled to the mobile device 241 measures an abnormal measurement, or simply takes a measurement regardless of the value. For instance, a home may be drawing too much current, or a water heater may be getting too hot, and as a result, the control system 230 is notified. The control system, in response to the notification can retrieve historical measurement data for the home, appliance or device, as well as neighboring homes and provide this information to the mobile device 241. In addition, step by step instructions can be provided to the field technician. In addition or alternatively, the control system 230 may request the technician to provide additional information such as the voltage level or other related information. In other circumstances, the field technician may be requested to take a picture which can then be loaded into the mobile device 241 through the interface unit 340. Other non-limiting examples may include the field technician entering a correct or incorrect access code, entering a value for a measurement, the field technician taking a digital picture, the field technician entering a request for more information or the like. In any of these embodiments, the mobile device 241 operates to send a trigger to the control system 230 in response to the mobile device detecting an action by the operator or an external device.

Another operator initiated trigger is when the mobile device 241 receives a serial number input as the result of a scan operation (such as a bar code scan), receives the input of a serial identification number from a device that is plugged into mobile device 241 or even as simply as the operator entering a serial number by hand using the key pad 350. Once the serial number is detected, the mobile device 241 can trigger the control system 230. The control system 230 can then operate to provide particular information attached to or related to the serial number to the mobile device 241. Again, the information provided can greatly vary depending on the particular embodiment of the present invention but, as a non-limiting example, the information may include historical information related to the product or entity associated with the serial number and identify problems previously associated with that serial number. The information can be provided in the form of text, pictures, audio, video, manuals, archived information pertaining to what happened before, what was done to alleviate the problems, what does particular entity look like, instructions on how to fix any problems, etc.

Another operator initiated trigger is referred to as call detail records. In one embodiment of the present invention, work orders can be sent to various field technicians by sending email or text messages to the mobile devices. In addition, the field technicians may keep the control system 230 apprised of the progress or status of the work order through sending reply emails or text messages. By defining a database of “special treatment” terms, the field technician can trigger various actions from the control system 230 by including special terms in the subject line of the reply or text message, or in some embodiments, including the terms in the body of the message or certain portions of the body. Thus, a database of trigger terms, or trouble or red-flag terms can be defined and maintained along with associated actions or data banks. If a user enters one of these terms, the mobile device will transmit the message to the control system 230 which can then operate accordingly. For example, a field service technician may enter the following terms on a subject line “check warranty”. In response to sending this message to the control system 230, the control system may detect the trigger words, look up the current warranty status for the particular product or customer, and provide this information back to the mobile device. This aspect of the invention can be implemented using rigidly defined fields and formats or may be implemented as the entrance of free form text.

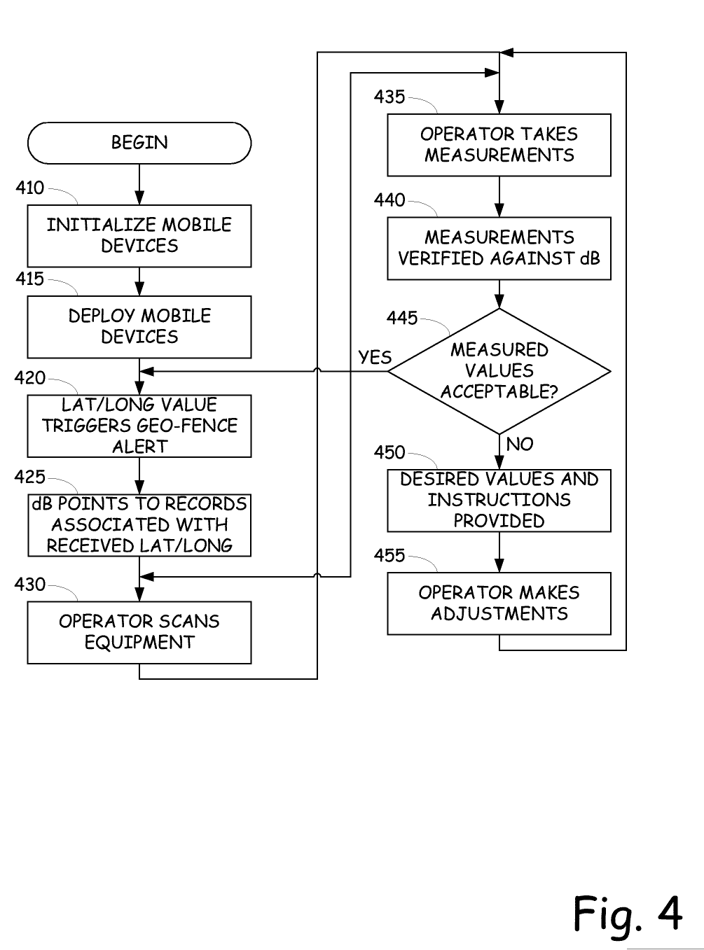

FIG. 4 is a flow diagram illustrating the steps involved in various embodiments of the present invention. A typical embodiment of the present invention involves multiple mobile devices to be deployed. At step 410, the mobile devices are initialized. The initialization can include a variety of procedures including associating the mobile devices with particular users or vehicles, provisioning the mobile devices to communicate with the GPS system and the radio communications system, and loading initial operating parameters, such as alert zones, into the mobile devices.

At step 415 the mobile devices are deployed. For instance, in an embodiment in which the mobile devices are utilized within a heating, ventilation and air-conditioning installation and maintenance company (HVAC), each of the trucks may include a mobile device and the deployment of the mobile devices simply involves sending the trucks out equipped with a mobile device. During operation, the deployed mobile devices may generate triggers to be sent back to the dispatch and control center. When the control center receives the trigger event, appropriate actions are taken. For example, at step 420, the mobile device generates a geo-fence trigger providing the current latitude and longitude position of the mobile device to the control system. The control system than analyzes the received triggering event and takes appropriate actions. In this example, at step 425, the control system operates to point the database system to the records associated with the particular received coordinates. Next, the operator associated with the mobile device may proceed to scan a piece of equipment that is located at the particular site represented by the latitude and longitude coordinates 430. The scan could be a scanning of a bar code or other encoded number, as well as other actions such as entering the serial number or model number of the equipment. This information can then be provided to the control system to further identify the correct records in the database system. The operator may then take measurements associated with the scanned equipment 435. The measurements can include a variety of measurements, and as a non-limiting example could include the Freon pressure, voltage input, temperature differential at the input versus the output, current drain, noise level in decibels, or the like. The measurement is then provided to the control system where it is verified against expected values within the database system 440. For instance, the database may include a range of acceptable measurements for the particular parameter, the particular equipment and the particular location. If the measurement is within this range of acceptable values 445, then processing can continue at one of a variety of locations. For instance, the operator could move the mobile device to a new location thereby triggering the provision of a new latitude and longitude pair 420. Alternatively, the operation may scan another piece of equipment at the current location 430. Yet again, alternatively the operator may take another measurement or retake the same measurement 435.

If the measured value at decision block 445 is not acceptable, then processing continues at step 450 where the desired values or range of values can be provided to the operator, along with a list of instructions or steps to take to remedy the situation. In response to this information, the operator can make the necessary adjustments and then take another measurement after the adjustments are in effect 435. Thus, the measurement/validation/correction loop can be repeated until the equipment is properly adjusted.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or aspects or possible combinations of the features or aspects. Variations of embodiments of the present invention that are described and embodiments of the present invention comprising different combinations of features noted in the described embodiments will occur to persons of skilled in the art. The present invention may be implemented by any one of, or any combination of, software, hardware, and/or firmware. In the description and claims, each of the verbs, “comprise” “include” and “have”, and conjugates thereof, are used to indicate that the object or objects of the verb are not necessarily a complete listing of members, components, elements or parts of the subject or subjects of the verb.

What is claimed is:

1. A system for facilitating the operation of deployed work forces, the system comprising:
a control system;
a plurality of mobile devices with each mobile device including a GPS receiver and a radio transceiver, the mobile device being operable to communication with the control system via the radio transceiver;
each of the plurality of mobile devices being operable to:
receive location identification information from the GPS receiver; and
transmit the location information to the control system; and
the control system operating to access database records based on the location identification information.

2. The system of claim 1, wherein the control system is operable to access database records based on the location identification information by:
receiving the location information from the mobile device;
examining a database based at least in part on the location identification information;
extracting relevant information from the database; and
transmitting the relevant information to the radio transceiver of the mobile device.

3. The system of claim 2, wherein each mobile device includes a display and each mobile device is further operable to:
receive the relevant information from the control system; and
display the relevant information on the display of the mobile device.

4. The system of claim 3, wherein the extracted relevant information may include a task to be performed by a user associated with the mobile device and request to perform the task and provide a result message, and the mobile device is further operable to:
receive the result message; and
transmit the result message to the control system; and
the control system being further operable to store the result message in the database for future reference.

5. The system of claim 3, wherein each of the mobile devices are further operable to:
receive an actuation signal; and
transmit a message to the control system based on the actuation signal; and
the control system is further operable to:
receive the message from the mobile device;
examine a database based at least in part on the actuation signal;
extract relevant information from the database; and
transmit the relevant information to the radio transceiver of the mobile device.

6. The system of claim 5, wherein the extracted relevant information may include a task to be performed by a user associated with the mobile device and request to perform the task and provide a result message, and the mobile device is further operable to:
receive the result message; and
transmit the result message to the control system; and
the control system being further operable to store the result message in the database for future reference.

7. The system of claim 3, wherein each of the mobile devices are further operable to:
receive an input message from a user; and
transmit the message to the control system; and
the control system is further operable to:
receive the message from the mobile device;
parse the message to identify any trigger terms;
if any trigger terms exist, examine a database based at least in part on the trigger term;
extract relevant information from the database; and
transmit the relevant information to the radio transceiver of the mobile device.

8. The system of claim 7, wherein the extracted relevant information may include a task to be performed by a user associated with the mobile device and request to perform the task and provide a result message, and the mobile device is further operable to:
receive the result message; and
transmit the result message to the control system; and
the control system being further operable to store the result message in the database for future reference.

9. A mobile device for operation in a system that facilitates the operation of deployed work forces, the mobile device comprising:
a location information receiver;
a radio transceiver;
an interface unit; and
a processor communicatively coupled to the location information receiver, the radio transceiver and the interface unit and, in response to instructions included in a memory component, is operable to:
receive location identification information from the location information receiver; and
if the mobile device is within a particular geographic vicinity, automatically transmit a location based signal that identifies the mobile device and the location identification information.

10. The mobile device of claim 9, further operable to:
in response to transmitting the location based signal, receive relevant information regarding equipment associated with the location identification information; and
display the relevant information on a display of the mobile device.

11. The mobile device of claim 9, wherein the mobile device is further operable to:
receive an actuation signal; and
transmit a message based on the actuation signal; and
receive relevant information transmitted to the radio transceiver of the mobile device in response to the transmission of the message based on the actuation signal.

12. The mobile device of claim 11, wherein the relevant information may include a task to be performed by a user associated with the mobile device and request to perform the task and provide a result message, and the mobile device is further operable to:
receive the result message; and
transmit the result message.

13. The mobile device of claim 9, wherein the mobile device is further operable to:
receive an input message from a user; and
transmit the message; and
receive relevant information pertaining to any trigger terms that were included in the transmitted message.

14. The system of claim 13, wherein the extracted relevant information may include a task to be performed by a user associated with the mobile device and request to perform the task and provide a result message, and the mobile device is further operable to:
receive the result message; and
transmit the result message.

15. A method for facilitating the operation of deployed work forces, the method comprising:
provisioning a plurality of mobile devices, each mobile device including a GPS receiver and a wireless radio transceiver;
deploying the plurality of mobile devices;
for a particular mobile device, receiving from the GPS receiver a current location for the mobile device;
sending a first trigger message to a control system, the first trigger message identifying the current location and the mobile device;
the control system searching a database based at least in part on the current location information;
the mobile device sending a second trigger message to the control system;
the control system extracting information from the database relevant to the current location and the second trigger message;
transmitting the relevant information to the particular mobile device.

16. A method for facilitating the operation of deployed work forces, the method comprising:
provisioning a plurality of mobile devices, each mobile device including a GPS receiver and a wireless radio transceiver;
deploying the plurality of mobile devices;
for a particular mobile device, detecting the occurrence of a trigger qualifying event;
transmitting a trigger message to a control system, the trigger message identifying the mobile device and a trigger type;
the control system searching a database based at least in part on the trigger type;
the control system extracting information relevant to the trigger type;
transmitting the relevant information to the particular mobile device.

17. The method of claim 16, wherein the step of detecting the occurrence of a trigger qualifying event comprises receiving location information from the GPS receiver.

18. The method of claim 16, wherein the step of detecting the occurrence of a trigger qualifying event comprises:
receiving location information from the GPS receiver; and
determining that the location information is within a threshold distance from an alert zone.

19. The method of claim 16, wherein the step of detecting the occurrence of a trigger qualifying event comprises receiving a measurement.

20. The method of claim 16, wherein the step of detecting the occurrence of a trigger qualifying event comprises receiving an input of a serial number.

21. The method of claim 16, wherein the step of detecting the occurrence of a trigger qualifying event comprises receiving an input of a message to be transmitted.
